(19) United States
(12) Patent Application Publication
(10) Pub. No.: US 2011/0108666 A1
(43) Pub. Date: May 12, 2011

(54) AIRCRAFT SEATS AND SEATING ARRANGEMENT

(75) Inventors: Alexander Nicholas Pozzi, Winston-Salem, NC (US); Tommy George Plant, Winston-Salem, NC (US)

(73) Assignee: BE AEROSPACE, INC., Wellington, FL (US)

(21) Appl. No.: 12/945,083

(22) Filed: Nov. 12, 2010

Related U.S. Application Data
(60) Provisional application No. 61/260,529, filed on Nov. 12, 2009.

(51) Int. Cl. B64D 11/06

(52) U.S. Cl. 244/118.6; 244/122 R

(57) ABSTRACT

An aircraft seating arrangement including a single-piece seat bottom frame having a plurality of laterally spaced-apart fore and aft legs for being attached to and supporting the seat frame on an aircraft deck and a plurality of seat bottoms supported on the seat frame. A plurality of seat back support frames are carried by the seat bottom frame aft of respective ones of the seat bottoms. A seat pan and seat back are positioned on respective seat bottoms and seat backs for passenger occupancy.

### TECHNICAL FIELD AND BACKGROUND OF THE INVENTION

This invention relates generally to an aircraft seats and seating arrangement, and more particularly to aircraft passenger seating engineered to have reduced weight, improved load-bearing characteristics, enhanced storage space and improved ergonomics.

A typical airline passenger seat has a back support carried by a lower seat frame supporting a seat bottom constructed of separately formed metal components. Weight of aircraft components is always an important factor in product selection and use because of the direct correlation between weight and fuel costs—a critical component in operating efficiency and total operating costs. Reduced seat weight and distribution not only achieves improved efficiency in the seat itself but also permits the weight of supporting deck structures to be reduced as well, resulting in substantial operating cost savings during the life of the seats. Single piece composite resin structures formed by various layup techniques permit very lightweight, yet strong, components to be utilized.

Ergonomic factors are also increasingly important. Many airlines now charge for checked baggage, increasing the tendency for passengers to carry as much luggage and other personal belongings onto the aircraft as possible to avoid these charges. This increases the importance of making as much space as possible beneath the seats available for storage and for placement of the feet of an aft-seated passenger. Most conventional coach-class passenger seats have legs that provide a relatively large central space under the center seat of a three-seat group, with two smaller spaces on either side, sometimes enclosed by curved bumper guards. This may cause aisle and window passengers, for example, to have less space for storage or foot placement than the center-seated passenger.

The equal leg spacing also permits the seat belt attachment points to placed in the same plane as the legs, thereby permitting the seating load to be carried more directly from the attachment points into the aircraft deck. This can reduce the load on each leg, more evenly distribute passenger loads into the deck during high g-loading caused by sudden deceleration, and reduce stress on the seat belts and attachment points.

### BRIEF SUMMARY OF THE INVENTION

Therefore it is an object of the present invention to provide an aircraft seating arrangement having a one-piece lower seat frame formed of a composite material including vertical supports and horizontal members carried by the vertical supports; and an upper back-support frame carried by the one-piece seat frame.

It is another object of the present invention to provide an aircraft seating arrangement having evenly spaced-apart legs in order to proved equal storage and/or foot space directly in front of each aft-seated passenger.

It is another object of the present invention to provide an aircraft seating arrangement wherein the seat legs and the seat belt attachment points are placed in the same plane as the legs, thereby permitting the seating load to be carried more directly from the attachment points into the aircraft deck.

It is another object of the present invention to provide an aircraft seating arrangement that provides equal storage or foot placement space for each passenger seated aft of the seating arrangement.

These and other objects and advantages of the invention are achieved by providing an aircraft seating arrangement including a single-piece seat bottom frame having a plurality of laterally spaced-apart fore and aft legs for being attached to and supporting the seat frame on an aircraft deck, and a plurality of seat bottoms supported on the seat frame. A plurality of seat back support frames are carried by the seat bottom frame aft of respective ones of the seat bottoms. A seat pan and seat back positioned on respective seat bottoms and seat backs for passenger occupancy.

According to one embodiment of the invention, the seat bottom frame is fabricated of a cured fibrous material and resin.

According to another embodiment of the invention, the seat bottom frame includes a plurality of integrally-formed uprights adapted for carrying seat belt elements for use by seat occupants.

According to yet another embodiment of the invention, the seat bottom frame includes a plurality of integrally-formed uprights extending in the same plane as the aft legs of the seat bottom frame and adapted for carrying seat belt elements for use by seat occupants.

According to yet another embodiment of the invention, the plurality of laterally spaced-apart fore and aft legs are equally spaced-apart for providing equal foot well and storage space between the legs for use by aft-seated passengers.

According to yet another embodiment of the invention, the seat pan and seat back are integrally-formed and define a continuous passenger support surface.

According to yet another embodiment of the invention, the plurality of seat back support frames each carry at least one passenger arm rest.

According to yet another embodiment of the invention, the plurality of seat back support frames each carry a meal tray movable between a stowed position proximate the seat back support frame and a deployed, substantially horizontal position for use by an aft-seated passenger.

According to yet another embodiment of the invention, an aircraft seat is provided, that includes a single-piece U-shaped seat bottom frame having a plurality of laterally spaced-apart legs for being attached to and supporting the seat frame on an aircraft deck and a seat bottom defined by a web of the seat bottom. A seat back support frame is carried by the seat bottom frame aft of the seat bottom; and a seat pan and seat back is positioned on the seat bottom and seat back for passenger occupancy.

According to yet another embodiment of the invention, the seat pan carries an arm rest.

According to yet another embodiment of the invention, the laterally spaced-apart legs each include a single planar panel defining a fore and aft extending bottom edge for supporting the seating arrangement.

According to yet another embodiment of the invention, an aircraft seating arrangement is provided and includes a plurality of single-piece U-shaped seat bottom frames, each having a plurality of laterally spaced-apart legs and a plurality of seat bottoms defined by a web of respective ones of the plurality of seat bottom frames. A plurality of seat back support frames are carried on respective ones of the seat bottom frames aft of the seat bottoms, and a plurality of seat pans and seat backs are positioned on respective ones of the seat bottoms and seat backs for passenger occupancy.

According to yet another embodiment of the invention, the laterally spaced-apart legs each have a single planar panel defining a fore and aft extending bottom edge for supporting the seating arrangement.

According to yet another embodiment of the invention, at least one intermediate leg is positioned between the plurality of laterally spaced-apart legs for defining equally spaced-apart foot wells and storage spaces between the legs for use by aft-seated passengers.

### BRIEF DESCRIPTION OF THE DRAWINGS

The subject matter that is regarded as the invention may be best understood by reference to the following description taken in conjunction with the accompanying drawing figures in which:

FIG. 1 is a perspective view of a seating arrangement according to one embodiment of the present invention;

FIG. 2 is a perspective view of the one-piece lower seat frame and upper back-support frames of the seating arrangement of FIG. 1;

FIG. 3 is a plan view of the arrangement of FIG. 1;

FIG. 4 is a plan view of the one-piece lower seat frame and upper back-support frames of the seating arrangement of FIG. 1 taken from the perspective of FIG. 2;

FIG. 5 is a front elevation view of the seating arrangement of FIG. 1;

FIG. 6 is a front elevation view of the one-piece lower seat frame and upper back-support frames of the seating arrangement of FIG. 1 taken from the perspective of FIG. 5;

FIG. 7 is a left-side elevation view of the seating arrangement of FIG. 1;

FIG. 8 is a left-side elevation view of the one-piece lower seat frame and upper back-support frames of the seating arrangement of FIG. 1 taken from the perspective of FIG. 7;

FIG. 9 is a right-side elevation view of the seating arrangement of FIG. 1;

FIG. 10 is a right-side elevation view of the one-piece lower seat frame and upper back-support frames of the seating arrangement of FIG. 1 taken from the perspective of FIG. 9;

FIG. 11 is another perspective view of the seating arrangement of FIG. 1;

FIG. 12 is a perspective view of the one-piece lower seat frame and upper back-support frames of the seating arrangement of FIG. 1 taken from the perspective of FIG. 11;

FIG. 13 is a perspective view of a seat according to another embodiment of the present invention;

FIG. 14 is a left-side elevation view of the seat of FIG. 13;

FIG. 15 is a right-side elevation view of the seat of FIG. 13;

FIG. 16 is a back elevation view of the seat of FIG. 13;

FIG. 17 is a front elevation view of the seat of FIG. 13;

FIG. 18 is another perspective view of the seat of FIG. 13.

FIG. 19 is a perspective view of a seat according to yet another embodiment of the present invention

FIG. 20 is a left-side elevation view of the seating arrangement of FIG. 19;

FIG. 21 is a right-side elevation view of the seating arrangement of FIG. 19;

FIG. 22 is a back elevation view of the seating arrangement of FIG. 19;

FIG. 23 is a front elevation view of the seating arrangement of FIG. 19; and

FIG. 24 is another perspective view of the seating arrangement of FIG. 19.

### DETAILED DESCRIPTION OF THE INVENTION

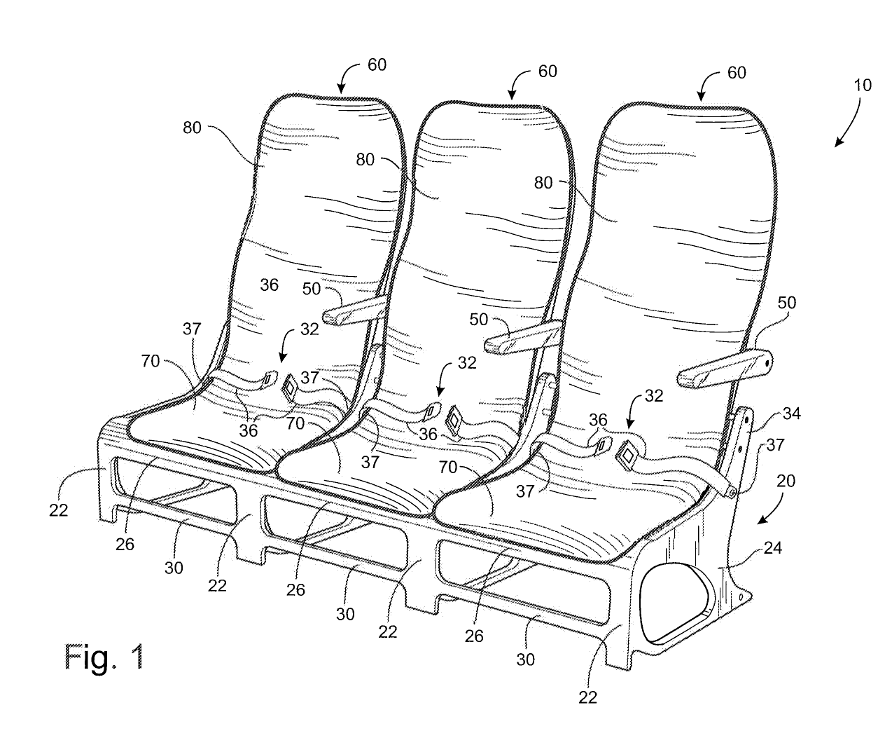

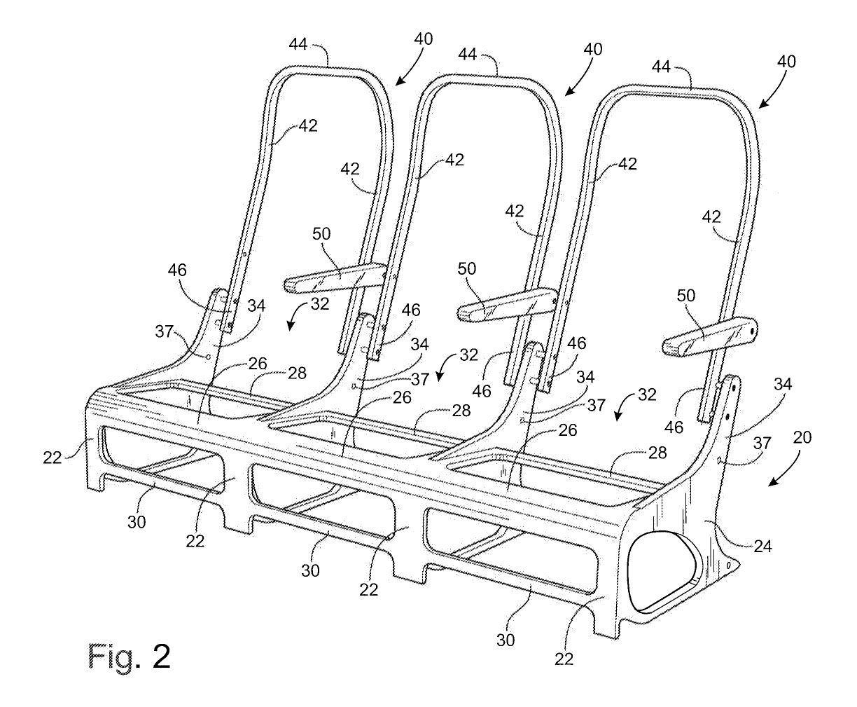

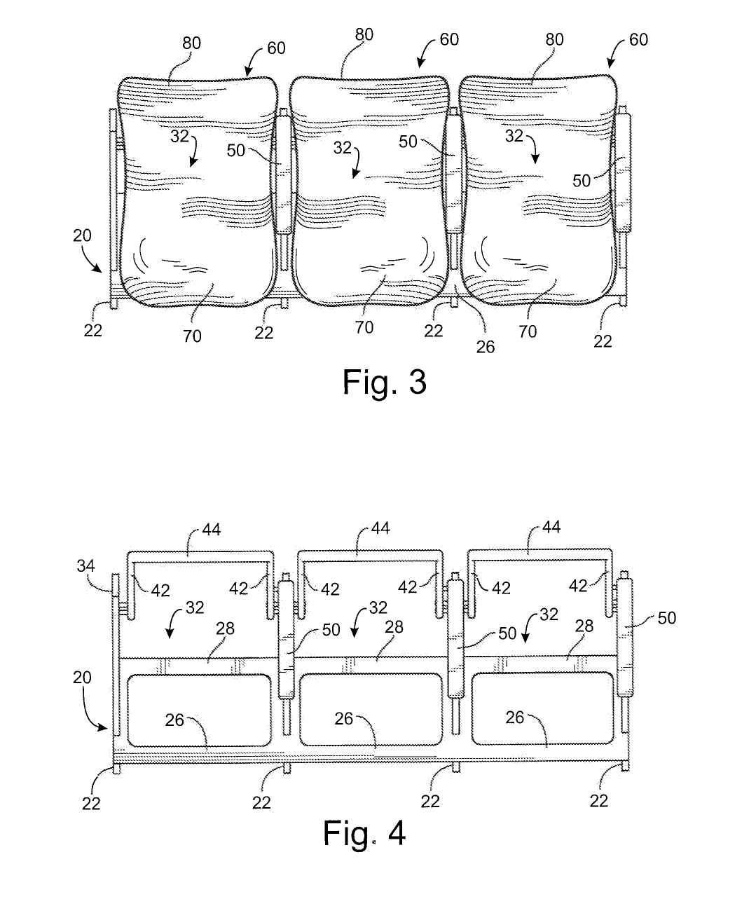

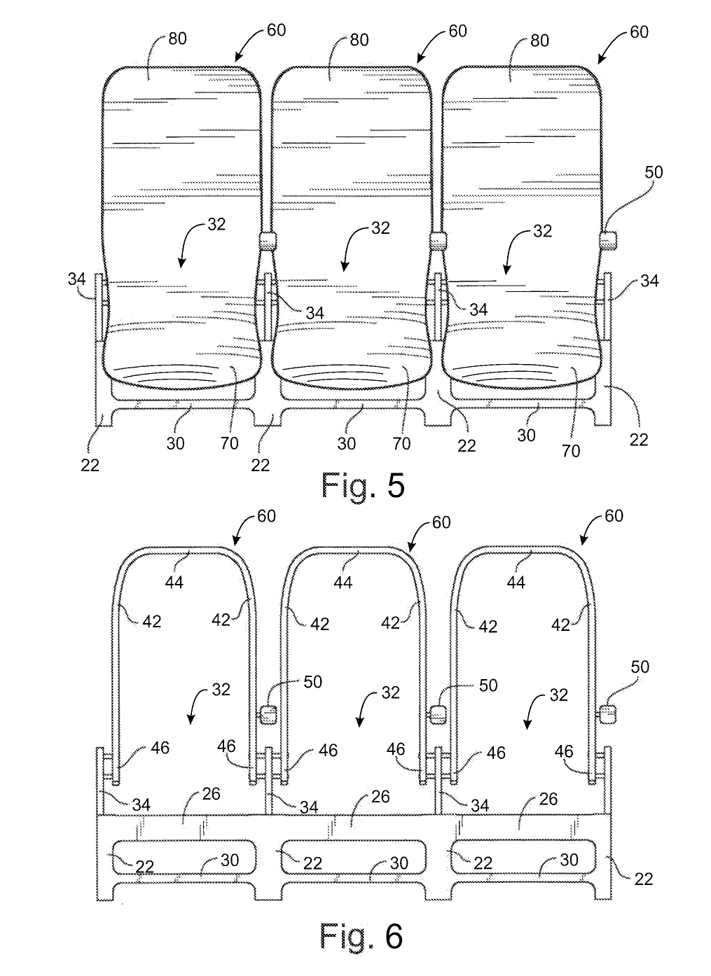

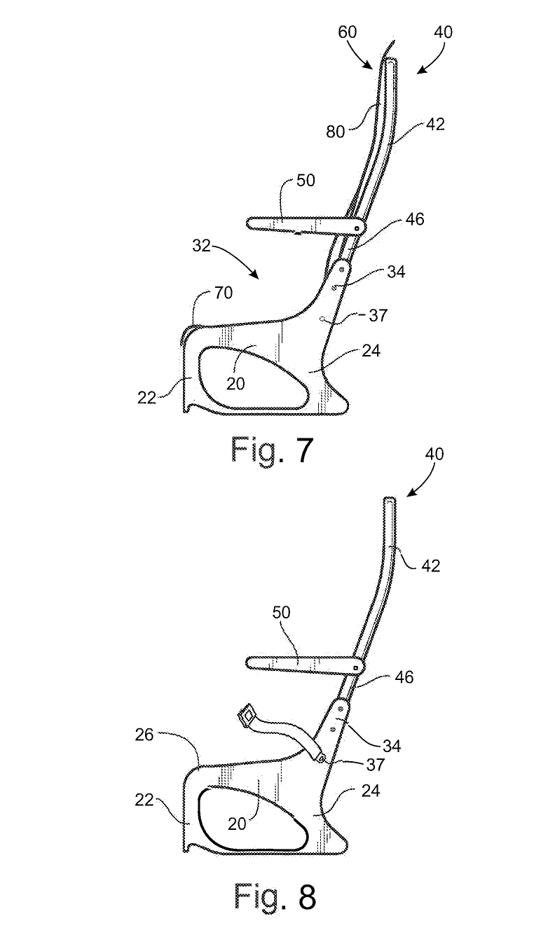

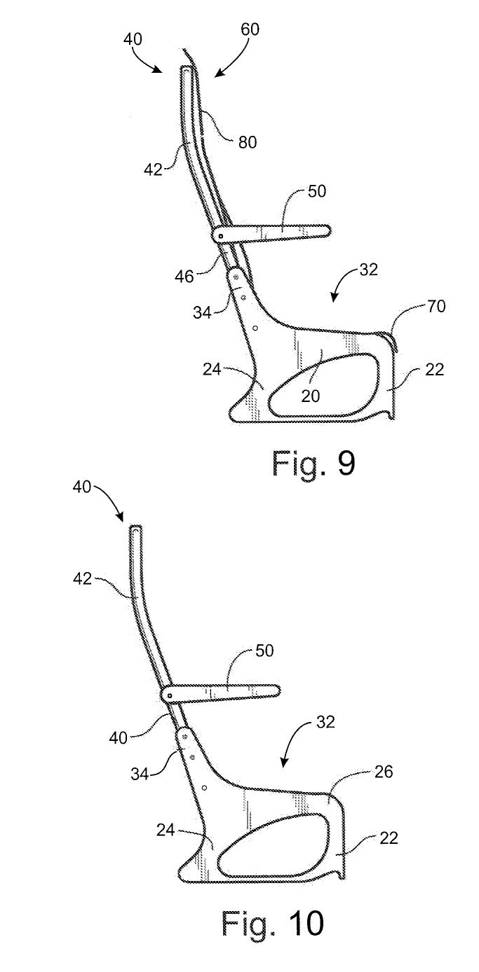

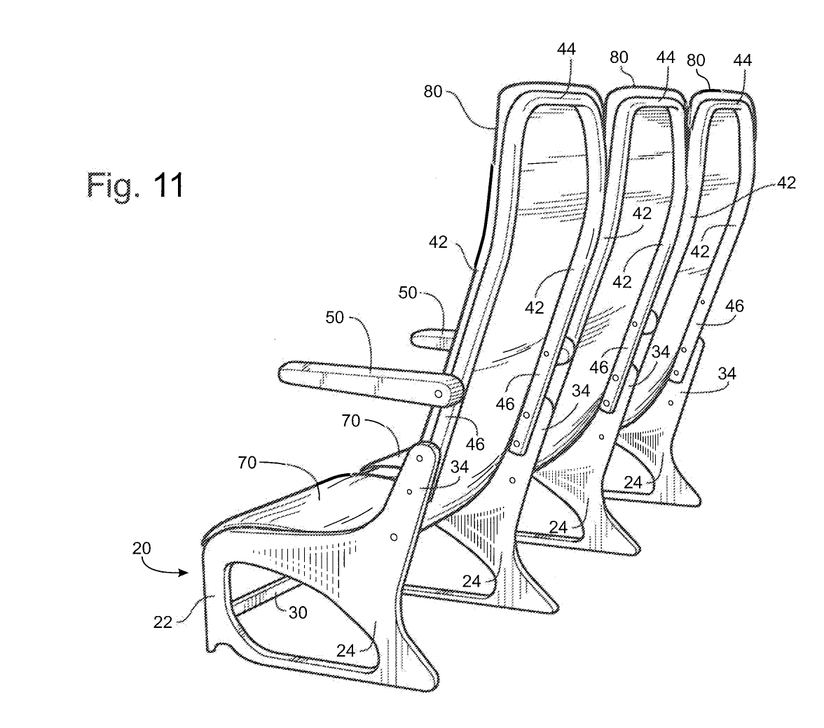

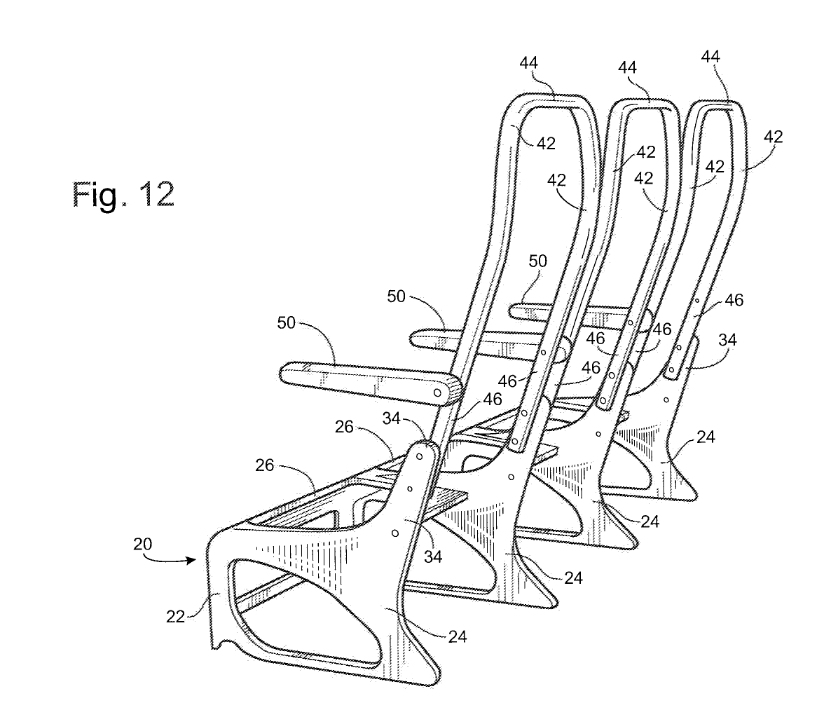

Referring now specifically to the drawings, FIG. 1 illustrates a passenger seating arrangement 10 for use on aircraft having a coach-class passenger cabin. The seating arrangement 10 is mounted in tracks extending along the length of a deck and secured to the tracks with conventional track fittings, not shown. FIGS. 1, 3, 5, 7, 9 and 11 show the seating arrangement 10 with its composite panels 60, each having a seat pan 70 and a back support 80. FIGS. 2, 4, 6, 8, 10 and 12 show the lower seat bottom frame 20 and multiple upper back-support frames 40 without the composite panels 60 to better show the constructions of the frames 20 and 40.

With particular reference now to FIGS. 2, 4, 6, 8, 10 and 12, the seat bottom frame 20 in the illustrated example is a one-piece, i.e., integrally-formed, structure formed of a composite material such as a carbon fiber textile material filled and coated with a hardened resin. Preferred fabrication techniques include “wet” layup and pre-impregnated fiber layup techniques. The “wet” layup process has been used since the advent of composites to create molded shapes from glass or carbon fiber and resin. Dry carbon fiber cloth is laid into a mold and resin is poured and brushed over the cloth. Layer upon layer are added and “squeegeed” into the cloth in this manner until the desired thickness is met.

The pre-impregnated (pre-preg) fiber method has been more recently developed to create stiffer, stronger laminates with controllable, predictable results. In this process the cloth is pre-impregnated with resin at a production facility, rolled on spools, and frozen to prevent the resin from curing prematurely. This material is cut and hand laid into a mold to the proper thickness and cured by one of two methods described below. The resulting laminate has a precisely controlled resin volume (+/−2%) and will be 20-30% stiffer and stronger than an equivalent-thickness wet laminate.

The first method of curing a pre-preg laminate is to put it under vacuum bag compaction and place it in an oven for the prescribed amount of time until the resin “glasses”, flows and hardens in the shape of the parent mold. The second method for curing the pre-preg laminate employs the same vacuum bag compaction as the first, but adds the extra force of the autoclave to heat the laminate under controlled pressure to cure the laminate. In both instances, the cure temperature will also be the maximum allowable temperature of the cured laminate with a continuous service temperature slightly lower. This temperature generally resides between 120 and 175 degrees Celsius.

The one-piece bottom frame 20 has front and back lower vertical supports 22 and 24, front and back seat-level horizontal members 26 and 28, and front lower horizontal members 30. As illustrated, the one-piece bottom frame 20 includes laterally adjacent multiple seating positions 32. Though the bottom frame 20 is illustrated to show 3 seating positions 32, more or less seating positions may be formed in the same manner as described above.

The bottom frame 20 also includes uprights 34 extending upwardly from the back lower vertical supports 24 that carry the upper back-support frames 40. Each upper back-support frame 40 is downward U-shaped, having laterally spaced riser portions 42 connected together by a horizontal portion 44. The lower ends 46 of the riser portions 42 are connected to the uprights 34 of the one-piece lower seat frame 20.

Armrests 50 are carried by the riser portions 42 of the upper back-support frames 40. The armrests 50 may be attached to the riser portions 42 in fixed positions or may be movable to raised positions to make passenger entry and exit from the seating arrangement 10 more convenient.

With particular reference now to FIGS. 1, 3, 5, 7, 9 and 11, the non-planar composite panels 60, each having a seat pan 70 and a back support 80, are carried by the bottom frame 20 and upper back-support frames 40. Each composite panel 60 is a one-piece structure formed of a composite material such as a carbon fiber textile material filled and coated with a hardened resin. Each composite panel 60 is contoured to fit a seated passenger. The seat pan 70 is contoured to support the buttocks of a seated passenger and the back support 80 is contoured to support the back of a seated passenger.

As clear from FIGS. 1 and 8, seat belts 36 are supplied for each seat in the seating arrangement 10. Seat belts 36 are attached by suitable attachment fittings to attachment holes 37 in the uprights 34 of the bottom frame 20. As shown, these attachment holes are by definition in the same vertical plane as the uprights 34 of the bottom frame 20. This permits the load on the seat belts 36 and the seating load to be carried more directly from the seat belt attachment fittings into the aircraft deck, while reducing the bending moment on the attachment fittings by locating g-loading force vectors in the same vertical plane as the uprights 34 of the bottom frame 20. This can reduce the load on each leg and more evenly distribute passenger loads into the deck during high g-loading on the seat belts 36 during sudden deceleration along the longitudinal axis of the passenger cabin. Because of the evenly-spaced leg arrangement, foot well and storage space is shared equally among aft-seated passengers.

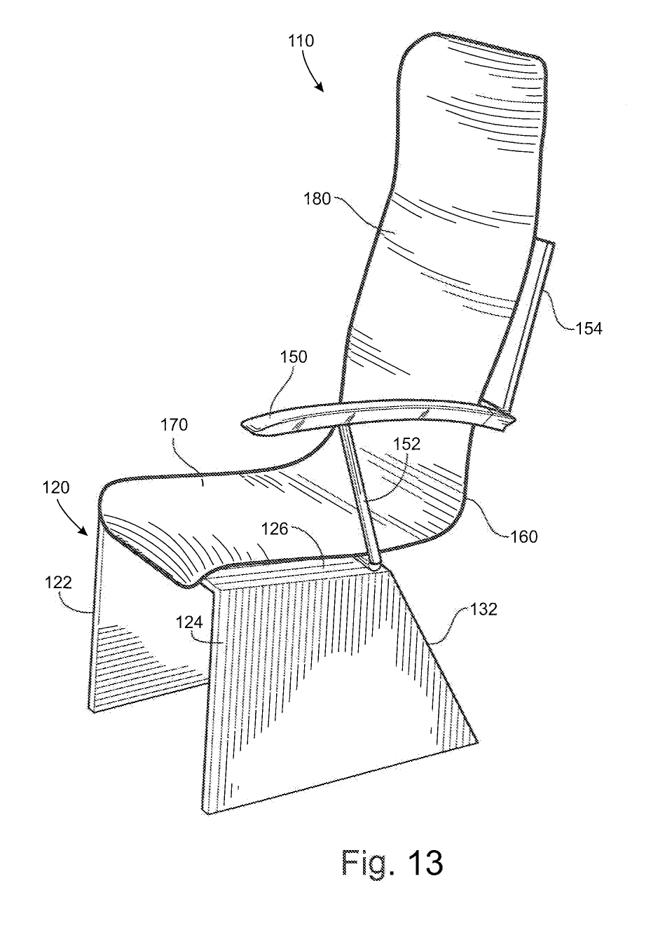

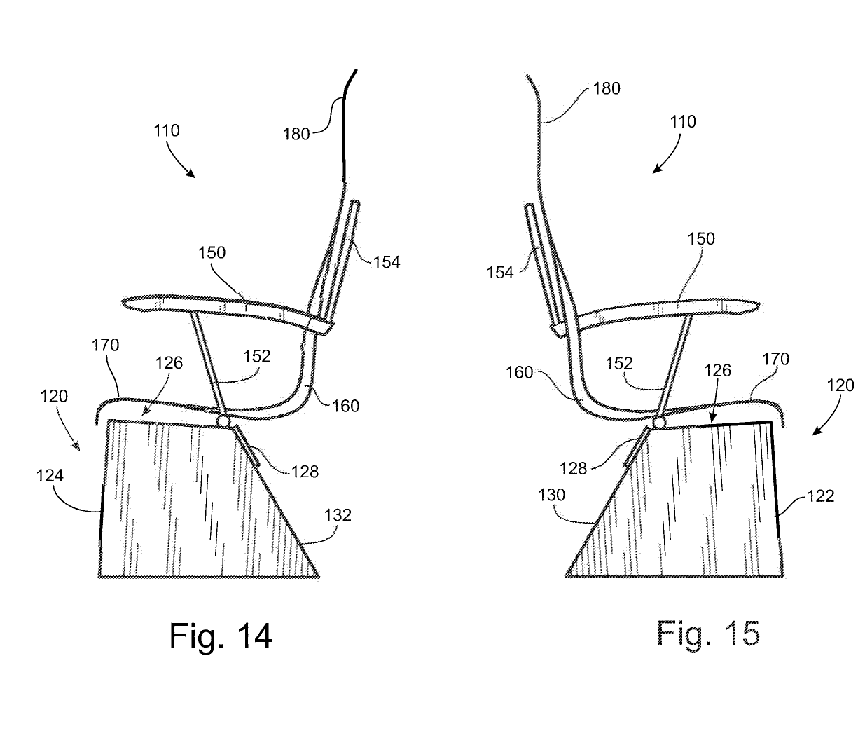

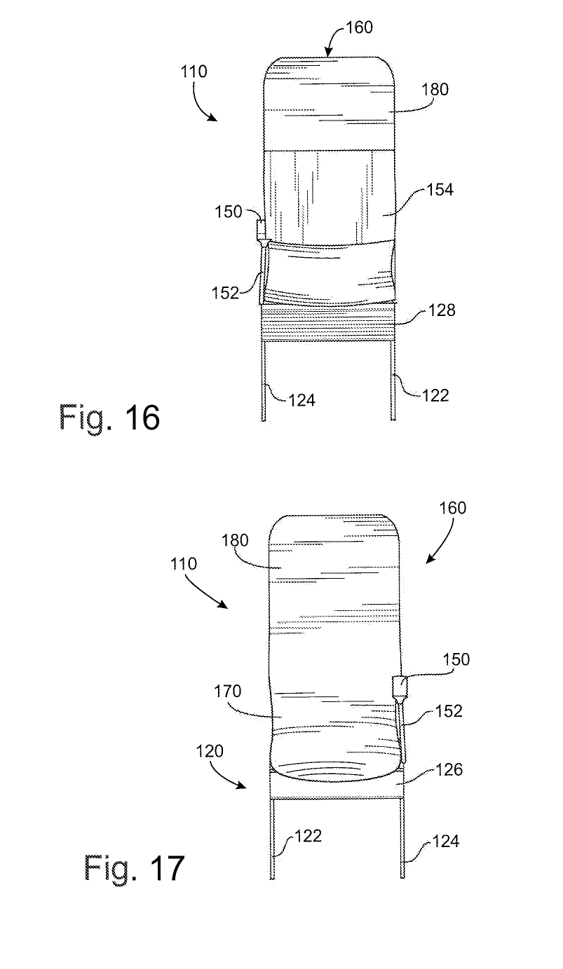

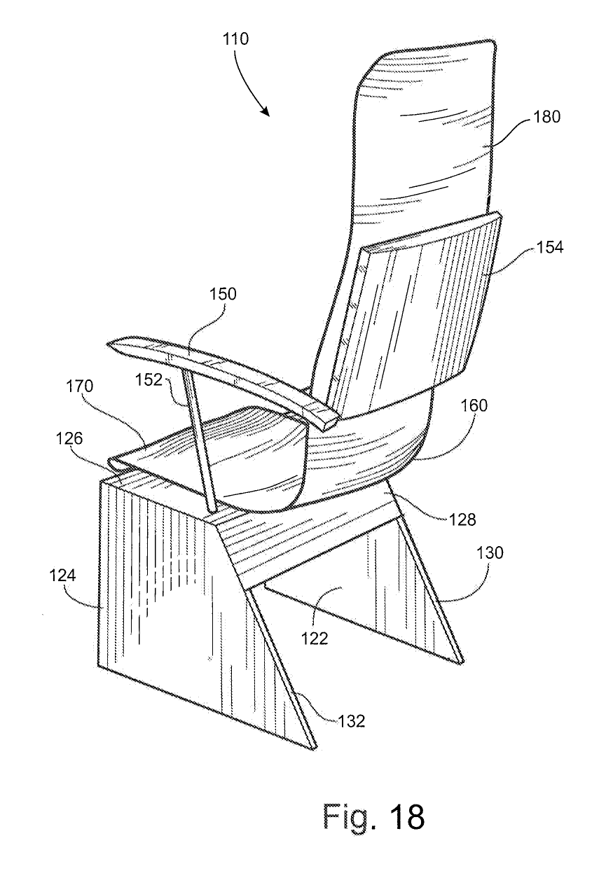

FIGS. 13-18 show views of a passenger seat 110 according to another embodiment of the invention. The passenger seat 110 includes a bottom seat frame 120 and a composite panel 160 having a seat pan 170 and a back support 180. The bottom seat frame 120 is a one-piece structure formed of a composite material such as a carbon fiber textile filled and coated with a hardened resin. The one-piece bottom seat frame 120 has laterally spaced vertical support panels 122 and 124, and a seat-level horizontal panel 126 extending between and carried by top margins of the vertical support panels 122 and 124. A strengthening panel 128, as shown particularly in FIG. 18, is attached to the diagonal back edges 130 and 132 of the vertical support panels 122 and 124 to improve the rigidity of the bottom seat frame 120.

The non-planar composite panel 160, having a seat pan 170 and a back support 180, is carried by the bottom seat frame 120. The composite panel 160 is a one-piece structure formed of a composite material such as a carbon fiber textile filled and coated with a hardened resin. The composite panel 160 is contoured to fit a seated passenger. The seat pan 170 is contoured to support the buttocks of a seated passenger and the back support 180 is contoured to support the back of a seated passenger.

An armrest 150 is supported by a bar 152 shown rising from a lateral side of the lower seat frame 120. A tray 154 is carried by the back of the back support 180 of the composite panel 160. The tray 154 is shown in its upright position against the back support 180, but is movable to a horizontal position for use by a passenger seated behind an particular passenger seat 110.

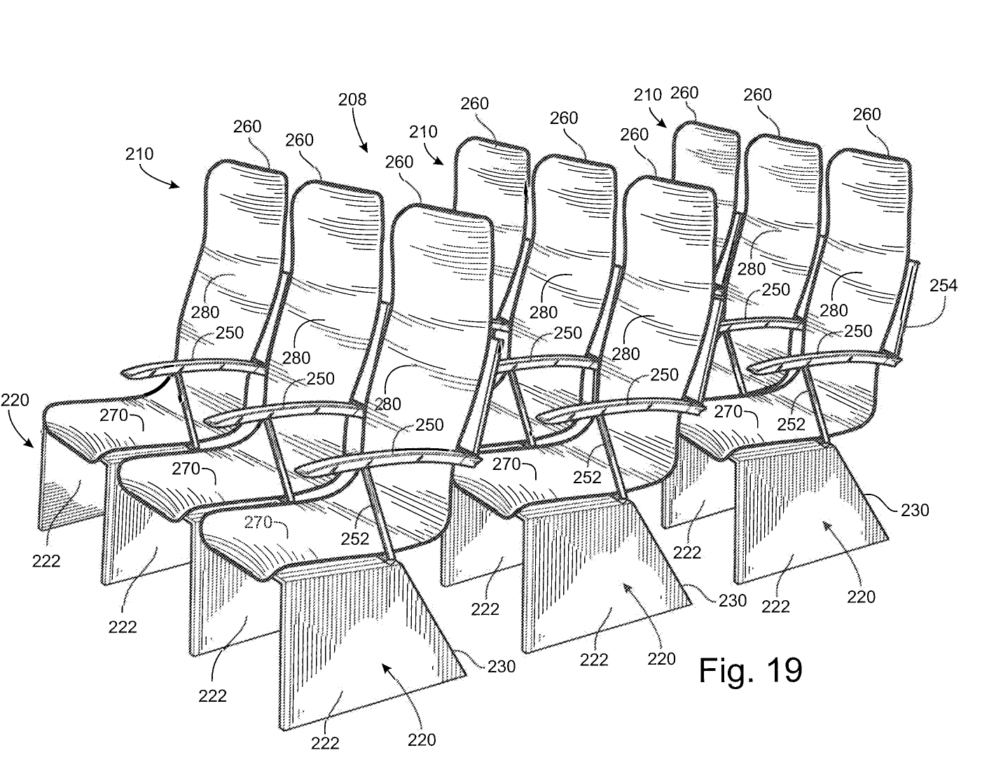

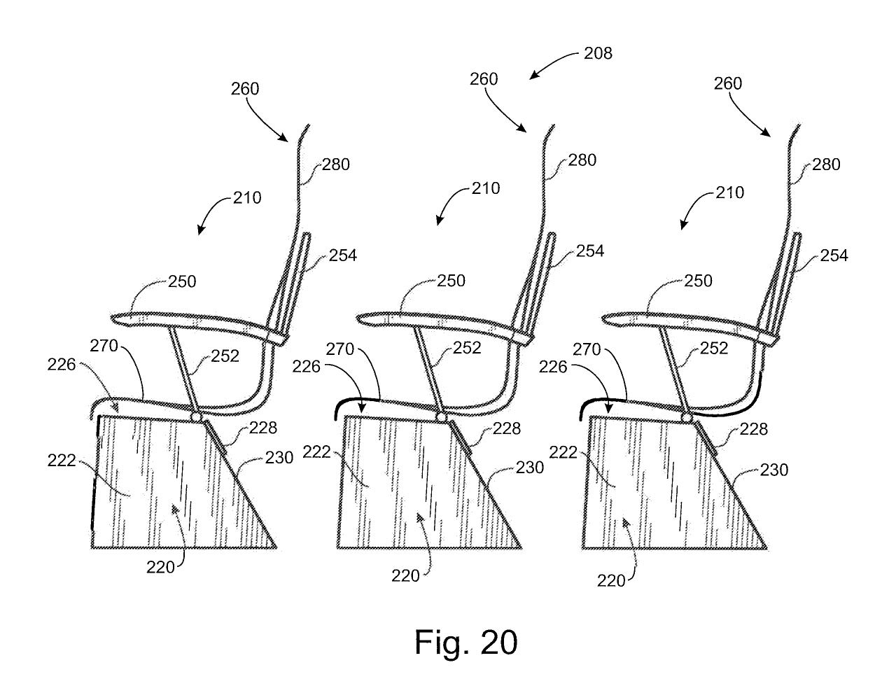

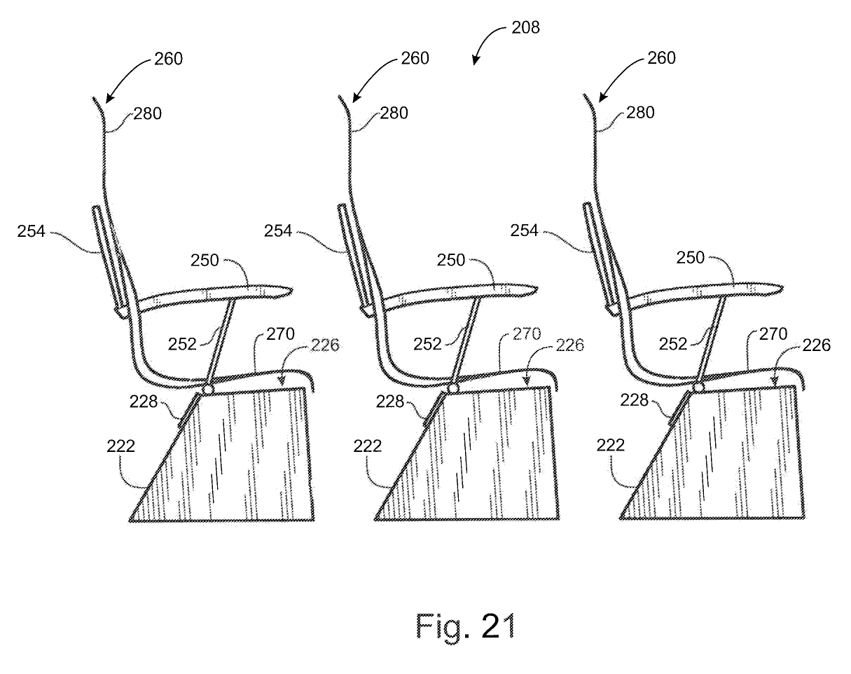

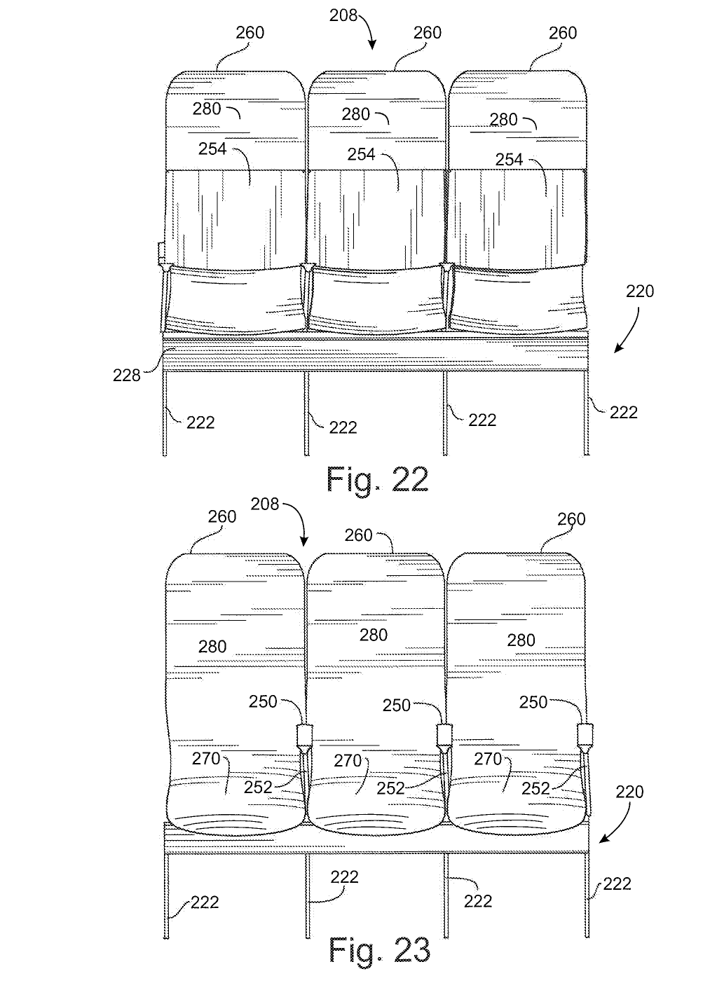

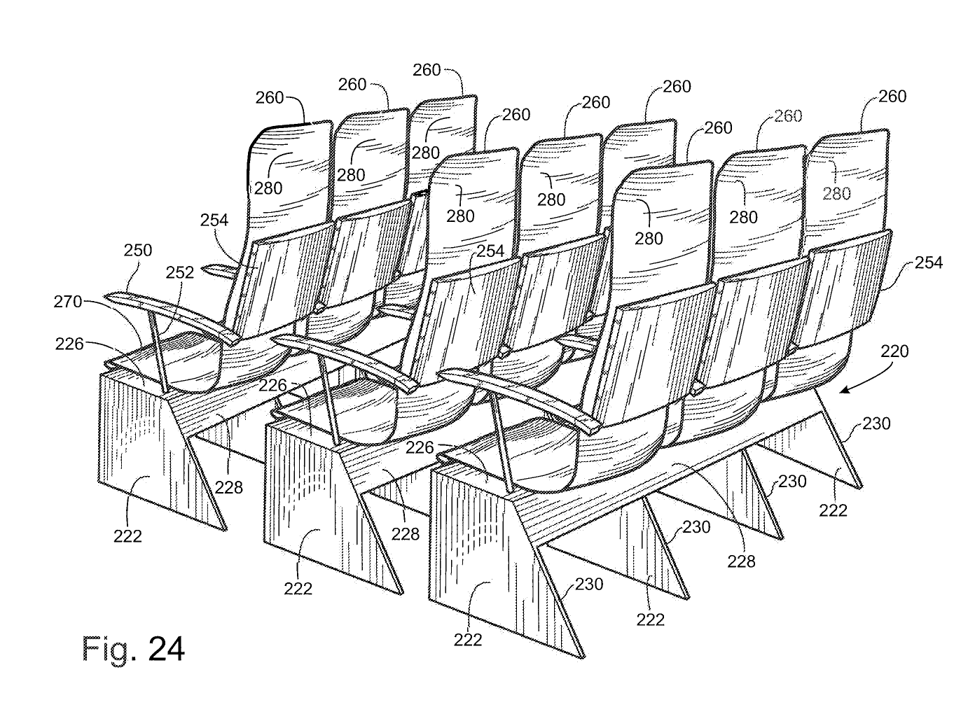

FIGS. 19-24 shows several rows of seats 210, each for seating three passengers. Each row of seats 210 includes a bottom seat frame 220 and a number of composite panels 260 having a seat pan 270 and a back support 280. The bottom seat frame 220 is a one-piece structure formed of a composite material such as a carbon fiber textile filled and coated with a hardened resin. The one-piece lower seat frame 220 has laterally spaced vertical support panels 222, and a seat-level horizontal panel 226 extending between and carried by top margins of the vertical support panels 222. A strengthening panel 228, as shown particularly in FIG. 24, is attached to the diagonal back edges 230 of the vertical support panels 222 to improve the rigidity of the lower seat frame 220.

As illustrated, the one-piece bottom seat frame 220 includes laterally adjacent multiple seating positions where non-planar composite panels 260 are carried by the seat frame 220. Each non-planar composite panel 260 has a seat pan 270 and a back support 280. Each composite panel 260 is a one-piece structure formed of a composite material such as a carbon fiber textile material filled and coated with a hardened resin, and each is contoured to accommodate a seated passenger. The seat pan 270 is contoured to support the buttocks of a seated passenger and the back support 280 is contoured to support the back of a seated passenger.

Along a lateral side of each seating position, an armrest 250 is supported by a riser bar 252 carried by the bottom seat frame 220. A tray 254 is carried by the back of each back support 280. The trays 254 are shown in their upright positions against the back supports 280, each being movable to a horizontal position for use by a passenger seated aft of any particular seating position.

While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. An aircraft seating arrangement comprising:
(a) a single-piece seat bottom frame having a plurality of laterally spaced-apart fore and aft legs for being attached to and supporting the seat frame on an aircraft deck;
(b) a plurality of seat bottoms supported on the seat frame;
(c) a plurality of seat back support frames carried by the seat bottom frame aft of respective ones of the seat bottoms; and
(d) a seat pan and seat back positioned on respective seat bottoms and seat backs for passenger occupancy.

2. An aircraft seating arrangement according to claim 1, wherein the seat bottom frame is fabricated of a cured fibrous material and resin.

3. An aircraft seating arrangement according to claim 1, wherein the seat bottom frame includes a plurality of integrally-formed uprights adapted for carrying seat belt elements for use by seat occupants.

4. An aircraft seating arrangement according to claim 1, wherein the seat bottom frame includes a plurality of integrally-formed uprights extending in the same plane as the aft legs of the seat bottom frame and adapted for carrying seat belt elements for use by seat occupants.

5. An aircraft seating arrangement according to claim 1, wherein the plurality of laterally spaced-apart fore and aft legs are equally spaced-apart for providing equal foot well and storage space between the legs for use by aft-seated passengers.

6. An aircraft seating arrangement according to claim 1, wherein the seat pan and seat back are integrally-formed and define a continuous passenger support surface.

7. An aircraft seating arrangement according to claim 1, wherein the plurality of seat back support frames each carry at least one passenger arm rest.

8. An aircraft seating arrangement according to claim 1, wherein the plurality of seat back support frames each carry a meal tray movable between a stowed position proximate the seat back support frame and a deployed, substantially horizontal position for use by an aft-seated passenger.

9. An aircraft seat, comprising:
(a) a single-piece U-shaped seat bottom frame having a plurality of laterally spaced-apart legs for being attached to and supporting the seat frame on an aircraft deck;
(b) a seat bottom defined by a web of the seat bottom;
(c) a seat back support frame carried by the seat bottom frame aft of the seat bottom; and
(d) a seat pan and seat back positioned on the seat bottom and seat back for passenger occupancy.

10. An aircraft seat according to claim 9, wherein the seat pan carries an arm rest.

11. An aircraft seat according to claim 9, wherein the laterally spaced-apart legs each comprise a single planar panel defining a fore and aft extending bottom edge for supporting the seating arrangement.

12. An aircraft seat according to claim 9, wherein the seat bottom frame is fabricated of a cured fibrous material and resin.

13. An aircraft seating arrangement, comprising:
(a) a plurality of single-piece U-shaped seat bottom frames, each having a plurality of laterally spaced-apart legs;
(b) a plurality of seat bottoms defined by a web of respective ones of the plurality of seat bottom frames;
(c) a plurality of seat back support frames carried on respective ones of the seat bottom frames aft of the seat bottoms; and
(d) a plurality of seat pans and seat backs positioned on respective ones of the seat bottoms and seat backs for passenger occupancy.

14. An aircraft seating arrangement according to claim 13, wherein the seat pan and seat back are integrally-formed and define a continuous passenger support surface.

15. An aircraft seating arrangement according to claim 13, wherein the plurality of seat back support frames each carry a meal tray movable between a stowed position proximate the seat back support frame and a deployed, substantially horizontal position for use by an aft-seated passenger.

16. An aircraft seating arrangement according to claim 13, wherein the seat bottom frame includes seat belt elements carried by the legs of the bottom support frame in a common plane with the legs of the bottom support frame for use by seat occupants.

17. An aircraft seating arrangement according to claim 13, wherein the laterally spaced-apart legs each comprise a single planar panel defining a fore and aft extending bottom edge for supporting the seating arrangement.

18. An aircraft seating arrangement according to claim 13, wherein the seat bottom frame is fabricated of a cured fibrous material and resin.

19. An aircraft seating arrangement according to claim 13, and including at least one intermediate leg positioned between the plurality of laterally spaced-apart legs for defining equally spaced-apart foot wells and storage spaces between the legs for use by aft-seated passengers.
